(19) United States
(12) Patent Application Publication
(10) Pub. No.: US 2008/0101067 A1
(43) Pub. Date: May 1, 2008

(54) LED lighting device

(76) Inventor: Dante Cariboni, Lecco (LC) (IT)

Correspondence Address: NIXON & VANDERHYE, PC, 901 NORTH GLEBE ROAD, 11TH FLOOR, ARLINGTON, VA, 22203, US

(21) Appl. No.: 11/589,757

(22) Filed: Oct. 31, 2006

(51) Int. Cl. F21V 5/00

(52) U.S. Cl. 362/245

(57) ABSTRACT

A lighting device (1; 101; 201; 301) for lighting objects is described, which comprises a printed circuit board (2) on which at least one LED light source (2) is mounted coupled to a primary optical assembly (3) for transmission and amplification of the light emitted by the light source, a containing body (5) enclosing the circuit board (2), and a secondary optical assembly (6) mounted on the containing body (5) at a suitable distance from the primary optical assembly (3) to generate at least one light beam leaving said lighting device.

The present invention refers to a lighting device based on LED (light emitting diode) sources, able to generate beams of light to illuminate walls, ceilings, corners, or any type of object.

Various types of lighting devices to illuminate objects are known to the art and are based mainly on incandescent lamps or halogen lamps, which insure a high light intensity.

The object of the present invention is to provide a lighting device based on LED sources, which is able to generate light beams having a high light intensity to illuminate any type of object, wall or corner.

Another object of the present invention is to provide such a lighting device that is versatile and able to provide various types of application and mounting, such as wall mounting or movably on a tilting system in spotlight mode mounting

Another object of the present invention is to provide such a lighting device that is reliable and at the same time easy to assemble and to produce.

These objects are achieved according to the invention with the characteristics listed in appended independent claim 1.

Advantageous embodiments of the invention are apparent from the dependent claims.

The lighting device for illuminating objects according to the invention comprises:

a printed circuit board on which at least one LED light source, coupled with a primary optical assembly for transmission and amplification of the light emitted by the light source, is mounted,

a containing body enclosing the circuit board, and

a secondary optical assembly mounted on the containing body at a suitable distance from the primary optical assembly to generate at least one light beam leaving said lighting device.

In this manner, by varying the disposition of the primary optical assembly on the circuit board and the disposition of the circuit board inside the containing body, the angle of incidence of the light on the secondary optical assembly can be varied, so as to obtain various configurations of light beams leaving the secondary optical assembly of the lighting device, according to the lighting requirements.

Further characteristics of the invention will be made clearer by the detailed description that follows, referring to purely exemplifying and therefore non-limiting embodiments thereof, illustrated in the appended drawings, in which:

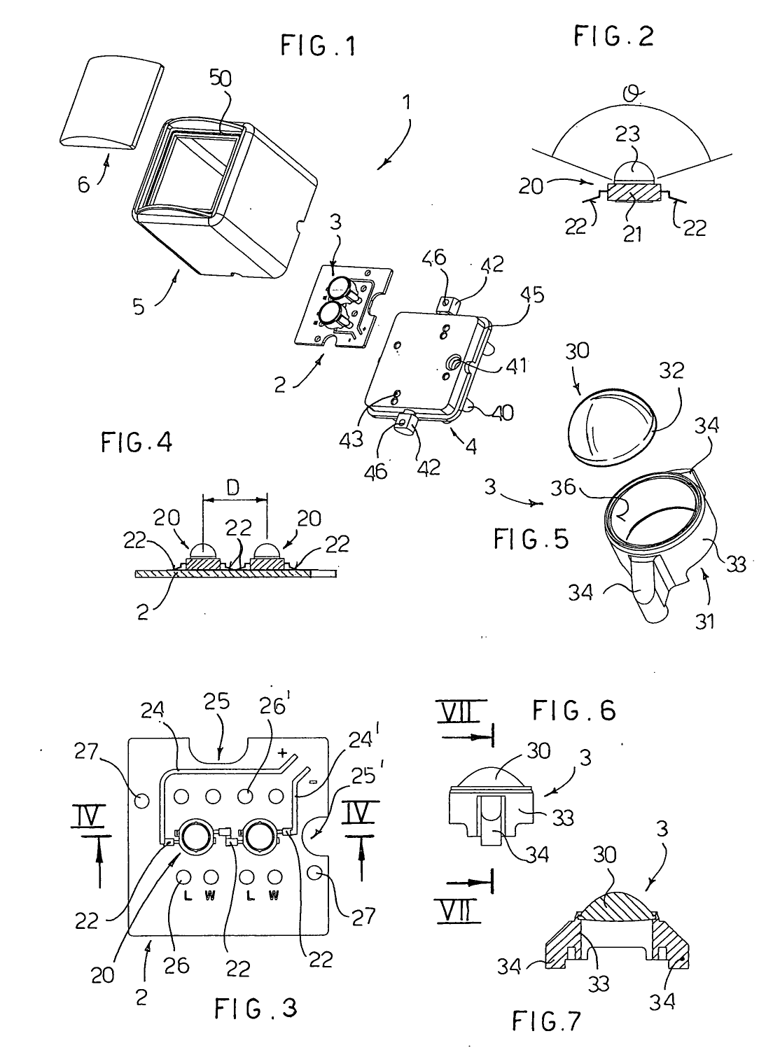

FIG. 1 is a perspective exploded view illustrating the basic components of the lighting device according to the invention;

FIG. 2 is an axial sectional view illustrating a LED used as a light source in the lighting device according to the invention;

FIG. 3 is a top plan view of a printed circuit board in which two LEDs are mounted;

FIG. 4 is a sectional view along the section plane IV-IV of FIG. 3;

FIG. 5 is a perspective exploded view illustrating a primary optical assembly consisting of a supporting cradle and of a primary lens;

FIG. 6 is a side view illustrating the assembled primary optical assembly;

FIG. 7 is an axial sectional view taken along the section plane VII-VII of FIG. 6;

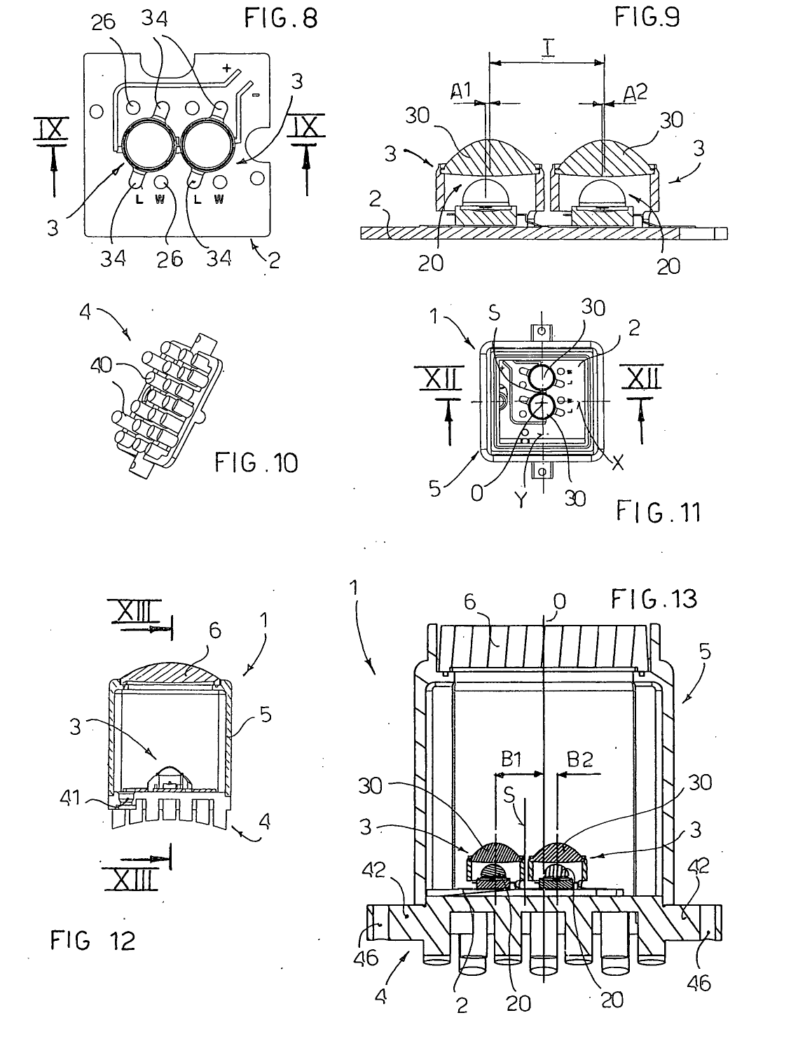

FIG. 8 it a top plan view illustrating the printed circuit board of FIG. 3, on which two primary optical assemblies are mounted;

FIG. 9 is a sectional view taken along the section plane IX-IX of FIG. 8;

FIG. 10 is a perspective view illustrating the bottom part of a heat sink used in the lighting device of FIG. 1;

FIG. 11 is a top plan view of the lighting device of FIG. 1 assembled;

FIG. 12 is a sectional view taken along the section plane XII-XII of FIG. 11;

FIG. 13 is an enlarged sectional view, taken along the section plane XIII-XIII of FIG. 12;

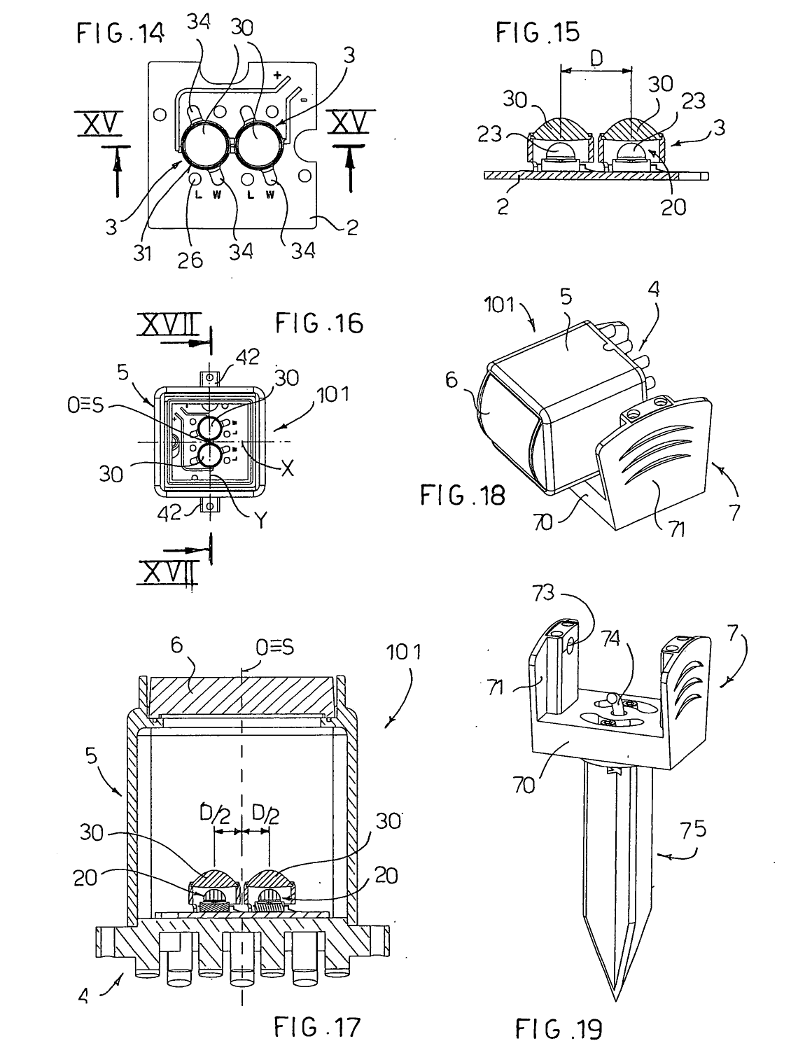

FIG. 14 is a top plan view of the circuit board, in which the primary optical assemblies are mounted differently with respect to FIG. 8 to implement a second embodiment of the invention;

FIG. 15 is a sectional view taken along the section plane XV-XV of FIG. 14;

FIG. 16 is a plan view of a lighting device according to the second embodiment, in which the circuit board of FIG. 14 has been mounted;

FIG. 17 is a sectional view along the section plane XVII-XVII of FIG. 16;

FIG. 18 is a perspective view illustrating the lighting device according to the second embodiment, mounted tiltingly on a supporting bracket;

FIG. 19 is a perspective view, illustrating the supporting bracket for tilting mounting of the lighting device mounted on a picket for anchoring it in a lawn;

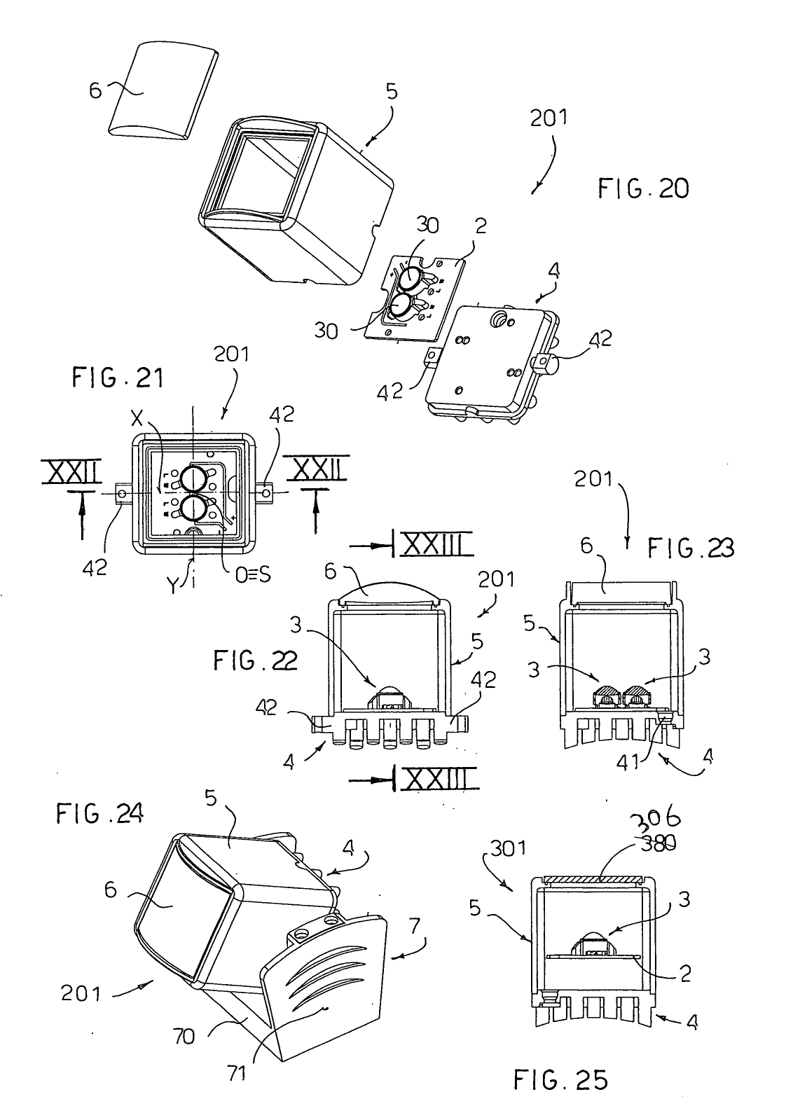

FIG. 20 is a perspective exploded view illustrating a lighting device according to a third embodiment of the invention;

FIG. 21 is a plan view of the lighting device of FIG. 20 assembled;

FIG. 22 is a sectional view taken along the section plane XXII-XXII of FIG. 21;

FIG. 23 is a sectional view taken along the section plane XXIII-XXIII of FIG. 22;

FIG. 24 is a perspective view illustrating a lighting device according to the third embodiment, mounted tiltingly on a support bracket; and

FIG. 25 is a sectional view like FIG. 12, but illustrating a fourth embodiment of the invention, in which a further optical element has been added.

With reference for now to FIGS. 1-13, a lighting device according to a first embodiment of the invention, indicated as a whole with the reference numeral 1, is described.

As shown in FIG. 1, the lighting device 1 comprises:

a printed circuit board 2, on which light sources coupled to respective primary optical assemblies 3 are mounted,

a heat sink 4 on which the circuit board 2 is mounted,

a containing body 5 mounted on the heat sink 4 to contain the circuit board 2, and

a secondary optical assembly 6 mounted on the body 5.

The light sources used in the lighting device 1 are LED (light emitting diodes). As shown in FIG. 2, the single LED 20 comprises an emitter 21 consisting of a chip of a solid-state device. Two metal terminals 22 are connected to the emitter 21 for the electrical supply. An optical lens 23, generally semi-spherical in shape, which forms the output surface of the light, is disposed on the emitter 21.

The LED 20 (of the Lambertian type), due to its morphology, emits light around its optical axis, according to a cone having an angle of aperture θ of about 140°. The LED 20 used has a high light intensity and can have a power of 1-3 W or greater, according to availability on the market.

As shown in FIGS. 3 and 4, the printed circuit board 2 of the lighting device 1 is substantially square-shaped, with a thickness of about 1.5 mm and is preferably made from an aluminium plate. Two LEDs 20 are mounted side by side, in a central position, on the circuit board 2 and are disposed along the midline of the board 2. As shown in FIG. 4, the LEDs 20 are equidistant from the respective side edges of the board and the distance D between the optical axes of the emitters of the LEDS 20 is about 14 mm.

Considering that lenses with a substantially convex light input surface are used, the term optical axis is used hereunder to indicate the axis passing through the centre of the light input surface of the lens and at right angles to the plane tangent to the centre of said light input surface.

The LEDS 20 are soldered on the board 2 and are connected to each other in series. That is to say, two terminals 22 of two LEDs 20 are connected to each other, whilst the other two terminals 22 of the LEDs are connected to respective conductive tracks (24, 24′) formed on the circuit board 2. The conductive tracks (24, 24′) lead towards a corner of the circuit board 2 to be connected respectively to the positive pole (+) and to the negative pole (−) of an electrical supply device, which supplies both LEDs 20 at the same time.

Respective window openings (25, 25′) for the passage of electrical supply cables are formed on both sides of the circuit board 2, in a central position.

Two rows of four holes (26, 26′) for fixing of the primary optical assemblies 3 are formed on the circuit board 2 on one side and on the other of the median line passing through the two LEDs 22. The letters L and W are alternately indicated on the board near the four aligned holes 26 to indicate the type of mounting of the primary optical assemblies 3.

Moreover, two further holes 27 are formed in the board 2 for mounting thereof on the heat sink 4 or on the body 5.

The light emitted by the LEDs 20 is not sufficient to provide adequate illumination. For this reason the LEDs 20 must be coupled to respective primary optical assemblies 3, which serve to amplify the light emitted by the LEDs 20 and to direct it in the desired direction.

As shown in FIGS. 5-7, the single primary optical assembly 3 used in the lighting device 1 comprises a primary optical lens 30 supported by a supporting cradle 31. The primary lens 30 is substantially paraboloid in shape and has a substantially convex light entry surface with a substantially circular perimeter and a curved, paraboloid-shaped light output surface. The primary lens 30 has a circular collar 32 protruding radially from its larger diameter edge. The primary lens 30 is made of a transparent plastic material, like PMMA (polymethylemethacryate).

The cradle 31 is made of hard heat-resistant plastic and has a substantially cylindrical hollow body 33 from which two tongues or feet 34 disposed in diametrically opposite positions protrude outwards. The inside diameter of the body 33 is slightly larger than the outside diameter of the LED 20 and its height is slightly greater than the height of the LED 20. A circumferential groove 36, inside which the collar 32 of the primary lens 30 is snap engaged, is formed in the upper internal edge of the cylindrical body 33 of the cradle 31.

As shown in FIGS. 8 and 9, the primary optical assemblies 3 are mounted on the printed circuit board 2 so that the LED 20 is contained inside the cylindrical body of the cradle 31 and the flat surface of the primary lens 30 is disposed above the lens 23 of the LED 20, almost in contact therewith.

In this first embodiment of the lighting element 1, as shown in FIG. 8, the tongues 34 of the cradles 31 are fixed in the holes 26 distinguished by the letter “L”. In this case, as shown in FIG. 9, assembly is eccentric or offset, that is to say the optical axes of the primary lenses 30 do not coincide with the respective optical axes of the LEDs 20.

To be exact, the distance A1 between the optical axis of the left-hand LED 20 (with reference to FIG. 9) and the optical axis of the respective coupled primary lens 30 is about 0.5 mm, whereas the distance A2 between the optical axis of the right-hand LED 20 (with reference to FIG. 9) and the optical axis of the respective coupled primary lens 30 is about 0.3 mm. As a result, the centre distance I between the two primary lenses 30 is about 13.8 mm.

It should be noted that since the emitters of the LEDs 20 are out of axis with respect to the primary lenses 30, the cones of light emitted by the two LEDs 20 are deviated when they meet the respective primary lenses 30. In this manner the primary lenses 30 generate light beams with a slight inclination towards the right (with reference to FIG. 9) with respect to their optical axis. To be exact, the beam leaving the first primary lens will have a greater inclination with respect to the beam leaving the second primary lens, since the distance A1 between the axis first of the primary lens and the axis of the respective LED is greater than the distance A2 between the axis of the second primary lens and the axis of the respective LED.

It must be considered that the LEDs 20 mounted on the board 2 develop a great heat during operation, above all towards the bottom surface of the circuit board 2. For this reason, the circuit board 2 is mounted on the heat sink 4 made of pressure die-cast aluminium.

As shown in FIG. 10, the heat sink 4 is shaped as a substantially square plate which has a plurality of cylindrical protrusions 40 disposed in the rear surface to dissipate the heat outward.

As shown in FIG. 1, the heat sink 4 has a through hole 41 for passage of the electrical supply cable. The electrical supply cable is sealed inside the hole 41 of the heat sink by means of special sealing resins both to ensure the desired degree of IP protection and for mechanical anchoring of the cable.

Two tongues 42 in the form of rounded pins provided with respective fixing holes 46 are provided at the side ends of the heat sink 4.

Holes 43 are formed in the flat front wall of the heat sink 4 to receive fixing screws of the circuit board 2. In any case the circuit board 2 is fixed on the heat sink also by means of a special paste disposed between the two elements, which improves heat conduction and compensates for any problems in the flatness of the contact surfaces.

A seat 45 on which the rear edge of the body 5 can abut is formed along the peripheral edge of the heat sink 4.

The body 5 is substantially parallelepiped-shaped and is made of pressure die-cast aluminium. The rear edge of the body 5 is glued into the seat 45 of the heat sink.

A seat 50 able to receive the secondary optical assembly 6 consisting of a single optical lens is formed in the upper edge of the body 5. The secondary lens 6 is substantially cylindrical in shape and has a substantially convex light input surface with a substantially square perimeter, and a curved light output surface with a substantially cylindrical curvature. That is to say, the secondary lens 6 is obtained from a square section of a cylinder. The secondary lens 6 serves to define the shape of the light beam leaving the lighting device 1.

However, as will be described in detail below, the shape of the light beam leaving the lighting device is defined by the arrangement of the primary lenses 30 with respect to the LEDs 20 and with respect to the secondary lens 6.

As shown in FIG. 11, the respective orthogonal axes of symmetry of the light input plane of the secondary lens 6 are indicated by X and Y. It must be considered that the axis X is transverse with respect to the axis of cylindrical curvature of the secondary lens 6; on the other hand the axis Y is parallel to the axis of cylindrical curvature of the secondary lens 6. The axes X and Y meet at a point 0 in which the optical axis of the secondary lens passes. The optical axis 0 is orthogonal to the light input plane.

In this first embodiment of the invention, the circuit board 2 is mounted eccentrically inside the body 5, so that the optical axes of the primary lenses 30 are situated on the Y axis, whilst the axis of symmetry between the optical axes of the two primary lenses 30, indicated by S, does not coincide with the optical axis O of the secondary lens 6.

As shown in FIG. 13, the distance B1 between the optical axis of the first primary lens 30 and the optical axis of the secondary lens 6 is about 12.25 mm, whereas the distance B2 between the optical axis of the second primary lens 30 and the optical axis of the secondary lens 6 is about 1.55 mm.

In this first embodiment of the invention the primary lenses 30 are mounted off-centre with respect to the respective LEDs 20 so as to generate an optical beam for both light sources deviated in the direction of the optical axis O of the cylindrical secondary lens 6. In this manner a light beam whose section assumes a shape of a so-called “blade of light” will leave the secondary lens.

The lighting device 1 according to the first embodiment of the invention can be used in wall or corner mounting, alone or in combination with other lighting devices of the same type. A single lighting device can have a remote power supply, whilst in the case of a plurality of lighting devices 1 the power supply can be integrated between them.

Like elements to those described will be indicated hereunder with the same reference numerals and a detailed description thereof will be omitted.

A lighting device 101 according to a second embodiment of the invention is described with the aid of FIGS. 14-19. In this second embodiment, as shown in FIGS. 14 and 15, the primary lenses 30 are mounted coaxial on the respective LEDs 20. For this purpose, the tongues 34 of the supporting cradles 31 of the primary lenses are fixed in the holes 26 of the circuit board 2 denoted by the letter W. In this case it must be noted that the centre distance between the two primary lenses 30 is equal to the centre distance between the two LEDs, indicated by D and equal to about 14 mm.

A shown in FIG. 16, in this second embodiment the circuit board 2 is mounted centred inside the body 5 so that the optical axes of the two primary lenses 30 pass through the axis Y and the axis of symmetry S of the two primary lenses 30 coincides with the optical axis O of the secondary lens 6. Thus, as shown in FIG. 17, the optical axes of the two primary lenses 30 are equidistant by a distance of D/2=7 mm with respect to he optical axis O of the secondary lens 6.

As a result the LEDs 20 generate respective cones of light which pass through the primary lenses 30 which generate respective light beams collimated in the direction of the secondary cylindrical lens 6 from which a light beam whose section assumes the shape of a so-called “blade of light” exits.

As shown in FIGS. 18 and 19, the lighting device 101 can be mounted tiltingly in a substantially U-shaped support bracket 7. The support bracket 7 comprises a base 70 from which two support plates 71 protrude. Respective holes 73 in which the two protruding tongues 42 of the heat sink 4 are pivoted are formed in the support plates 71.

In this manner the lighting device can rotate around the axis passing through the two protruding tongues 42 of the heat sink, which is parallel to the axis Y passing through the two optical axes of the two primary lenses 30.

A hole is formed in the base 70 of the bracket 7 through which the electrical supply cable 74, which will be inserted in the hole 41 of the heat sink 4, passes. As shown in FIG. 19, a pointed picket 75 able to be anchored to a soft terrain, such as a lawn, can be provided in the base 70 of the bracket 7.

A lighting device 201 according to a third embodiment of the invention is described with reference to FIGS. 20-24. In this third embodiment the only change with respect to the second embodiment is represented by the fact the circuit board 2 supporting the LEDs 20 and the primary optical assemblies 3 is rotated 90° with respect to the position illustrated in the second embodiment and thus the circuit board 2 is applied on the heat sink 4.

With reference to FIG. 21, it should be noted that in the lighting device 201 according to the third embodiment, the pivot tongues 42 of the heat sink are disposed along an axis parallel to the axis X of the secondary lens 6.

In this case, when the lighting device 201 is mounted on the bracket 7, as shown in FIG. 24, it takes on a configuration rotated 90° around the optical axis O of the secondary lens 6 with respect to the configuration taken on by the lighting device 101 in FIG. 18.

In this manner, the lighting device 201 according to the third embodiment can be used to generate symmetrical light beams with different apertures on the two planes of projection (tangential plane of projection and sagittal plane of projection). These light beams generated by the lighting device 201 are commonly called wall-washers.

In FIG. 25 a lighting device 301 according to a fourth embodiment of the invention is illustrated. The lighting device 301 has a configuration similar to that of the lighting device 101 of the second embodiment. However, in the lighting device 301 the cylindrical secondary lens 6 is replaced by a flat secondary lens 306 of transparent glass.

In this fourth embodiment of the invention, the beam emitted by the lighting device 301 will have a cone-shaped angular aperture with its apex near the output plane of the flat secondary lens 306. The angular aperture of the light beam will depend upon the position of the primary optical assembly 3 with respect to the secondary lens 306. The smaller the distance between the primary optical assembly 3 and the secondary lens 306, the greater the angular aperture of the conical light beam. For this purpose, as shown in FIG. 25, the circuit board 2 is disposed inside the body 5, distanced from the heat sink 4, so as to reduce the distance between the primary lenses 30 and the secondary lens 306.

Even if in the previous embodiments reference has always been made to a LED 20 around which a cradle 31 which supports a respective primary lens 30 is mounted, said assembly (LED 20—cradle 31—primary lens 30) can be replaced by one or more pre-collimated LED light sources with an angle of aperture of the emitted light beam of about 30°-40°. In this case the primary lens is an integral part of the LED light source.

Numerous changes and modifications of detail within the reach of a person skilled in the art can be made to the above-disclosed embodiments of the invention without departing from the scope of the invention as set forth in the appended claims.

1. A lighting device (1; 101; 201; 301) for lighting objects, comprising:
a printed circuit board (2), on which at least one LED light source (20) coupled to a primary optical assembly (3) for transmission and amplification of the light emitted by said light source is mounted,
a containing body (5) enclosing said circuit board (2), and
a secondary optical assembly (6) mounted on said containing body (5) at a suitable distance from said primary optical assembly (3) to generate at least one light beam leaving said lighting device.

2. A lighting device (1; 101; 201; 301) according to claim 1, characterised in that said primary optical assembly (3) comprises a supporting cradle (31) mounted on said circuit board (2) around said LED (20) and supporting a substantially paraboloid-shaped primary lens (30), which has a substantially convex light input surface and a paraboloid-shaped curved light output surface, said primary lens (30) being disposed above said LED (20), almost in contact therewith.

3. A lighting device (1; 101; 201; 301) according to claim 2, characterised in that said primary lens (30) is made of PMMA (polymethylmethacrylate).

4. A lighting device (1; 101; 201) according to claim 1, characterised in that said secondary optical assembly comprises a substantially semicylindrical secondary lens (6) with a substantially convex light input surface and light output surface curved in a cylinder shape.

5. A lighting device (301) according to claim 4, characterised in that said secondary optical assembly comprises a secondary lens (306) shaped as a flat plate.

6. A lighting device (1; 101; 201; 301) according to claim 4 or 5, characterised in that said secondary lens (6; 306) is made of glass.

7. A lighting device (1; 101; 201; 301) according to claim 1, characterised in that it comprises a bottom wall (4) closing the containing body (5), said bottom wall (4) acting as a heat sink and being provided with a plurality of outward facing protrusions (40).

8. A lighting device (1; 101; 201; 301) according to claim 7, characterised in that said bottom wall (4) comprises two tongues (42) protruding outward in opposite directions and provided with holes (46) for fixing to a support or able to be hinged tiltingly to a bracket (7) for configuration as a spotlight.

9. A lighting device (1; 101; 201; 301) according to claim 1, characterised in that it comprises two LEDs (20) disposed side by side along a midline of the circuit board (2) and coupled to two respective primary optical assemblies (3).

10. A lighting device (1; 101; 201; 301) according to claim 9, characterised in that the centre distance (D) between the optical axes of said two LEDs (20) is about 14 mm.

11. A lighting device (101; 201; 301) according to claim 9, characterised in that said primary lenses (30) of the primary optical assemblies are mounted with the respective optical axes coaxial with the optical axes of said two LED (20).

12. A lighting device (101; 201; 301) according to claim 11, characterised in that said circuit board (2) is mounted inside said body (5) so that the optical axis (O) of said secondary lens (6, 306) coincides with the axis of symmetry (S) of the optical axes of the primary lenses (30).

13. A lighting device (1) according to claim 9, characterised in that said primary lenses (30) of the primary optical assemblies are mounted with the respective optical axes offset with respect to the optical axes of said two LEDs (20).

14. A lighting device (1) according to claim 13, characterised in that the distance (A1) between the optical axis of a primary lens (30) and the optical axis of the respective coupled LED (20) is about 0.5 mm and the distance (A2) between the optical axis of the other primary lens (30) and the optical axis of the respective coupled LED (20) is about 0.3 mm, so that the centre distance (I) between the optical axes of the two primary lenses (30) is about 13.8 mm.

15. A lighting device (1) according to claim 14, characterised in that said circuit board (2) is mounted off centre inside said body (5) so that said optical axis (O) of said secondary lens (6) does not coincide with the axis of symmetry (S) of the optical axes of the primary lenses.

16. A lighting device (1) according to claim 14, characterised in that the distance (B1) between the optical axis of a primary lens (30) and the optical axis (O) of the secondary lens (6) is about 12.25 mm, and the distance (B2) between the optical axis of the other primary lens (30) and optical axis (O) of the secondary lens (6) is about 1.55 mm.

17. A lighting device (1; 101; 201; 301) according to claim 1, characterised in that said body (5) is substantially parallelepiped shaped with a square cross section and is made of aluminium.

18. A lighting device according to claim 1, characterised in that it comprises at least one or more pre-collimated LED light sources, with an angle of aperture of the emitted light beam of about 30°-40°, and a primary lens that is an integral part of said LED light source.
